(19) United States
(12) Patent Application Publication
(10) Pub. No.: US 2025/0233200 A1
(43) Pub. Date: Jul. 17, 2025

(54) SOLID LITHIUM-ION BATTERY AND METHOD FOR MANUFACTURING A CATHODE THEREOF

(71) Applicant: PHOENIX BATTERY CORPORATION, HSINCHU CITY (TW)

(72) Inventors: YU-KAI LIAO, HUALIEN COUNTY (TW); SHU-FEN HU, NEW TAIPEI CITY (TW); RU-SHI LIU, NEW TAIPEI CITY (TW); SUNG-TING YAO, TAOYUAN CITY (TW)

(21) Appl. No.: 18/743,363

(22) Filed: Jun. 14, 2024

(30) Foreign Application Priority Data
Jan. 11, 2024 (TW) 113101176

(51) Int. Cl. H01M 10/0562; H01M 10/0525; H01M 10/058

(52) U.S. Cl. CPC H01M 10/0562; H01M 10/0525; H01M 10/058; H01M 2300/0071

(57) ABSTRACT

A solid lithium-ion battery includes a solid electrolyte and a cathode. The cathode, formed on the surface of the solid electrolyte, includes lithium-metal chloride. The cathode has an alloy and an artificial solid electrolyte interphase layer. Thus, an interface between the solid electrolyte and the cathode has better wettability.

### BACKGROUND OF THE INVENTION

This application claims priority for the TW patent application No. 113101176 filed on 11 Jan. 2024, the content of which is incorporated by reference in its entirely.

### FIELD OF THE INVENTION

The present invention relates to a solid lithium-ion battery, particularly a solid lithium-ion battery, and a method for manufacturing a cathode thereof that improves wettability.

### DESCRIPTION OF THE RELATED ART

With the development of the electric vehicle and drone industries, battery life has received more and more attention. Lithium-ion batteries are the mainstream battery today. However, traditional lithium-ion batteries use organic electrolytes. Thus, lithium-ion batteries have large volumes and risks such as explosion and leakage.

In order to solve the foregoing problems, solid lithium-ion batteries using solid electrolytes have been provided. The solid electrolyte is mainly a garnet-type solid electrolyte. However, the garnet-type solid-state electrolyte and lithium metal as a cathode (or an anode) have poor wettability, resulting in very high interface impedance between the garnet-type solid-state electrolyte and the lithium metal. In addition, the garnet-type solid electrolyte will form cavities in long-term charge and discharge activities, causing polarization problems in the reduction of lithium ions. Long-term use will cause lithium dendrites to grow at the grain boundaries of the garnet-type solid electrolyte, causing the garnet-type solid electrolyte to fail and short-circuiting the solid lithium-ion battery. As shown in FIG. 1, there are multiple gaps 16 at the interface between the solid electrolyte 12 and the cathode 14, resulting in very high interface impedance. Cavities 18 are formed in the solid electrolyte 12. For the convenience of explanation, FIG. 1 only shows the solid electrolyte 12 and the cathode 14 of the solid lithium-ion battery 10, and the other parts (such as the anode) are not shown.

The most direct manner to solve the problem of wettability is to use an artificial solid electrolyte interphase (SEI) layer or an alloy of lithium metal and different metal elements. The present solid lithium-ion batteries can only use artificial SEI layers or alloys to improve wettability rather than use artificial SEI layers or alloys to improve wettability at the same time.

### SUMMARY OF THE INVENTION

One objective of the present invention is to provide a solid lithium-ion battery and a method for manufacturing a cathode thereof that improves wettability.

According to an embodiment of the present invention, a solid lithium-ion battery includes a solid electrolyte and a cathode. The cathode, formed on the surface of the solid electrolyte, includes lithium metal chloride. The cathode has an alloy and an artificial solid electrolyte interphase layer. Accordingly, an interface between the solid electrolyte and the cathode has better wettability.

A method for manufacturing the cathode of a solid lithium-ion battery includes coating a metal-ion chloride solvent on a surface of a solid electrolyte, drying the metal-ion chloride solvent coated on the solid electrolyte to obtain metal-ion chloride, forming lithium metal on the metal-ion chloride, and performing an alloying process on the metal-ion chloride and the lithium metal to form an interface layer having an alloy and an artificial solid electrolyte interphase layer between the solid electrolyte and the lithium metal, wherein the lithium metal and the interface layer form the cathode of the solid lithium-ion battery. Since the cathode has an alloy and an artificial solid electrolyte interphase layer, an interface between the solid electrolyte and the cathode has better wettability.

Below, the embodiments are described in detail in cooperation with the drawings to make easily understand the technical contents, characteristics, and accomplishments of the present invention.

### BRIEF DESCRIPTION OF THE DRAWINGS

FIG. 1 is a cross-sectional view of a conventional solid lithium-ion battery;

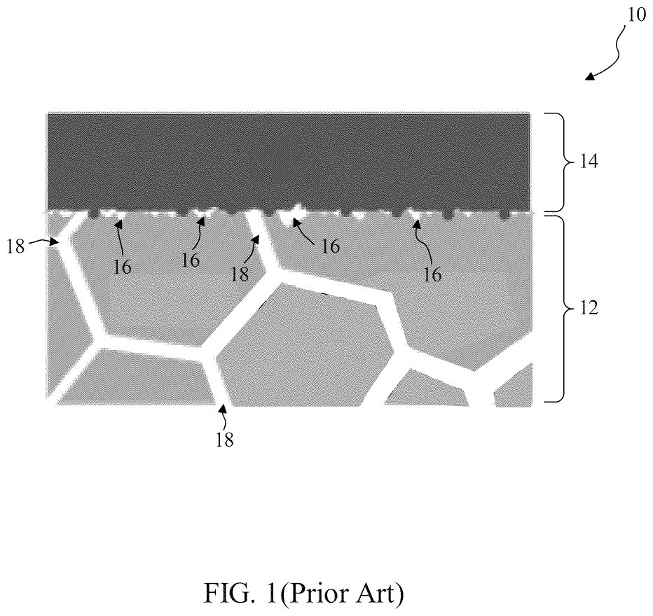

FIG. 2 is a cross-sectional view of a solid lithium-ion battery of the present invention;

FIG. 3 is a flowchart of a method for manufacturing the cathode of the solid lithium-ion battery of FIG. 2;

FIG. 4 is a diagram showing the voltage variation of the solid lithium-ion battery of the present invention in practical operation; and

FIG. 5 is a diagram showing the capacity to potential curves of the solid lithium-ion battery of the present invention after charging and discharging.

### DETAILED DESCRIPTION OF THE INVENTION

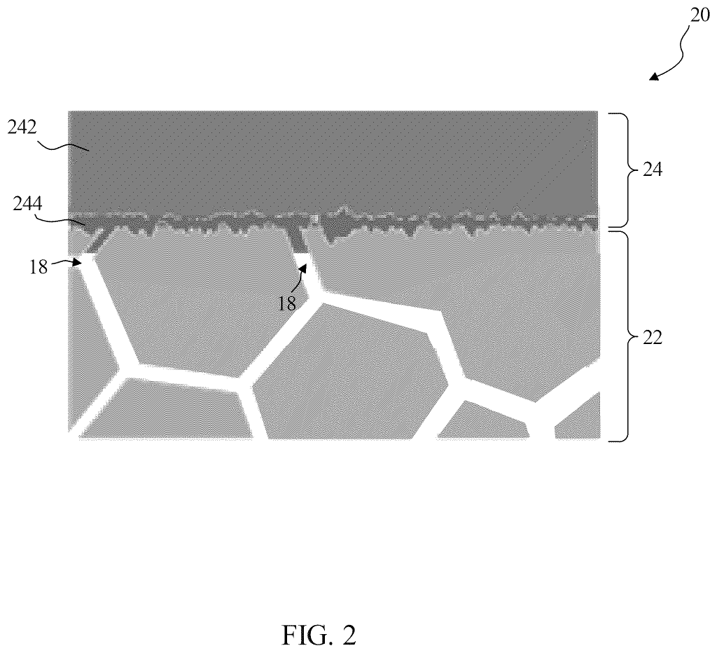

FIG. 2 shows the solid lithium-ion battery of the present invention. For the convenience of explanation, the solid lithium-ion battery 20 in FIG. 2 only shows a solid electrolyte 22 and a cathode 24. The other parts of the solid lithium-ion battery 20 are not shown, such as the anode (or cathode) of the solid lithium-ion battery 20. The solid electrolyte 22 may be, but not limited to, a garnet-type solid electrolyte. For example, the solid electrolyte 22 may be lithium lanthanum zirconium tantalum oxide (LLZTO). The cathode 24 is formed on the solid electrolyte 22 and includes lithium metal 242 and an interface layer 244. The interface layer 244 includes alloy and an artificial solid electrolyte interphase (SEI) layer. Since the interface layer 244 functions as both the alloy and the artificial SEI layer, the cathode 24 and the solid electrolyte 22 of the present invention have better wettability. The alloy in the interface layer 244 includes but is not limited to lithium calcium alloy, lithium indium alloy, lithium tin alloy, or lithium silicon alloy. The artificial SEI layer in interface layer 244 includes lithium chloride (lithium metal chloride). The interface between the lithium chloride and the solid electrolyte 22 has no gap, thus reducing the interface impedance. In addition, the lithium chloride can also fill the cavities 18 of the surface of the solid electrolyte 22 to prevent lithium dendrites from growing at the grain boundaries of the solid electrolyte.

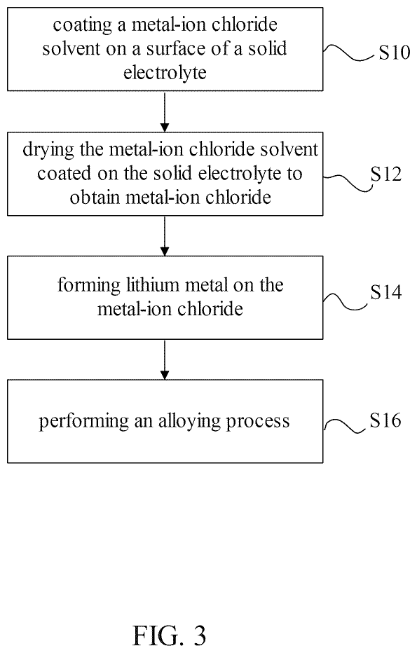

FIG. 3 shows a method for manufacturing the cathode of the solid lithium-ion battery in FIG. 2. The method for manufacturing the cathode in FIG. 3 includes Step S10. In Step S10, a metal-ion chloride solvent is coated on a surface (such as the upper surface) of the solid electrolyte 22. In one embodiment, 0.01, 0.02, 0.03, 0.04, 0.05, 0.06, or 0.07 grams of calcium chloride (CaCl₂)) can be mixed with 1 ml of isopropanol and 1 ml of ethanol in a sample bottle for 1 hour to obtain the metal-ion chloride solvent, but the present invention is not limited thereto. In one embodiment, 5, 10, or 15 microliters of the metal-ion chloride solvent can be coated on the upper surface of the solid electrolyte 22 by drop casting, but the present invention is not limited thereto. In one embodiment, the metal-ion chloride solvent can be coated on the upper surface of the solid electrolyte 22 by spin coating. The spin coating method includes: spinning at 500 rpm for 20 seconds, followed by spinning at 2000 rpm for 5 seconds; spinning at 1000 rpm for 30 seconds, followed by spinning at 3000 rpm for 10 seconds; or spinning at 1500 rpm for 40 seconds, followed by spinning at 4000 rpm for 15 seconds., but the present invention is not limited thereto.

After the metal-ion chloride solvent is coated on the surface of the solid electrolyte 22, the metal-ion chloride solvent coated on the solid electrolyte 22 is dried to obtain the metal-ion chloride, as shown in Step S12. In one embodiment, the solvent drying method includes placing the solid electrolyte 22 coated with the metal-ion chloride solvent in a glove box filled with argon gas and heating it to 40, 50, or 60° C. to dry the solvent. Metal-ion chloride may be a conductor, semiconductor, or non-conductor. The metal-ion chloride is lithiophilic. Metal-ion chloride may be, but it is not limited to calcium chloride, silicon chloride, indium chloride, or tin chloride.

After drying the solvent, Step S14 is performed to form lithium metal 242 on the metal-ion chloride. Finally, Step S16 is performed to perform an alloying process on the metal-ion chloride and the lithium metal 242 to form an interface layer 244 having alloy and an artificial solid electrolyte interphase layer between the solid electrolyte 22 and the lithium metal 242, wherein the lithium metal 242 and the interface layer 244 form the cathode 24 of the solid lithium-ion battery 20. In one embodiment, the alloying process includes heating the lithium metal 242, the interface layer 244, and the solid electrolyte at 400° C. for 2 minutes, followed by lowering to room temperature, but the present invention is not limited thereto. In one embodiment, the alloying process includes heating the lithium metal 242, the interface layer 244, and the solid electrolyte at 460° C. for 3 minutes, followed by lowering to room temperature, but the present invention is not limited thereto. In one embodiment, the alloying process includes heating the lithium metal 242, the interface layer 244, and the solid electrolyte at 540° C. for 5 minutes, followed by lowering to room temperature, but the present invention is not limited thereto. In one embodiment, the reaction temperature of the alloying process is 460˜540° C., preferably 480˜540° C., but the present invention is not limited thereto.

There are many methods for fabricating the solid electrolyte 22. Here, take a method for fabricating the garnet-type solid electrolyte of LLZTO as an example. Assume that the formula of lithium lanthanum zirconium tantalum oxide is Li_{6.75}La₃Zr_{1.75}Ta_{0.25}O₁₂. According to the mole ratio of lithium atoms:lanthanum atoms:zirconium atoms:tantalum atoms=7.425:3:1.75:0.25 (because lithium atoms are easy to evaporate during a sintering process, lithium atoms of 10 weight percentage is additionally obtained for compensation) materials such as lithium hydroxide, lanthanum oxide, zirconium oxide, and tantalum oxide are weighed. Then, add isopropyl alcohol and perform ball milling on the foregoing materials at 300 rpm for 12 hours to uniformly mix each material into a suspension. The suspension is placed in an alumina crucible and dried at a temperature of 70° C. for 12 hours and then sintered at a temperature of 900° C. for 12 hours to obtain cubic phase LLZTO. After the sintering process is completed, ball milling is performed at 300 rpm for 12 hours to homogenize the powder. The powder is placed into a mold with a diameter of 12 mm, and a force of 20 metric tons is applied for 1 minute. Then, the powder is demolded to obtain a tablet precursor with a diameter of 12 mm and a thickness of 3 mm. The tablet precursor is placed in an alumina crucible and covered with twice the weight of matrix powder to prevent lithium from evaporating. Afterward, it is sintered in the air at a temperature of 900° C. for 4 hours and then sintered at a temperature of 1100° C. for 12 hours. After the sintering process is completed, the matrix powder on the tablet precursor is removed and polished to obtain the solid electrolyte 22, LLZTO.

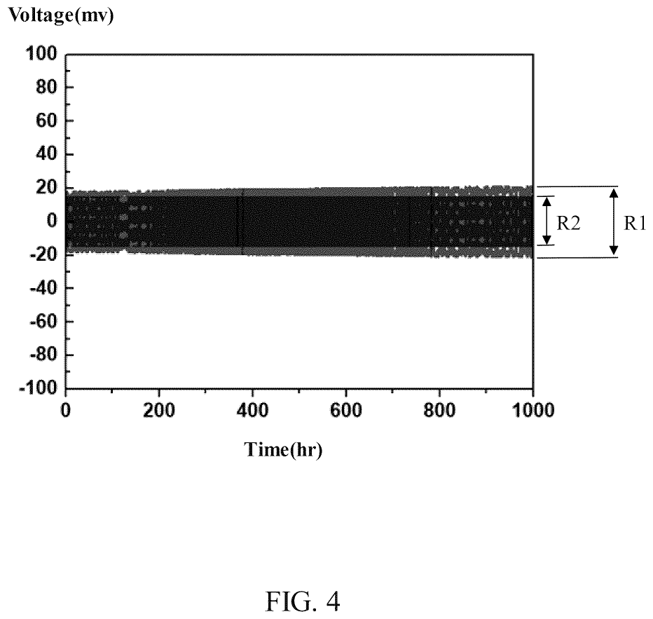

FIG. 4 shows the voltage variation of the solid lithium-ion battery of the present invention in practical operation. FIG. 4 respectively shows the ranges R1 and R2 of the voltage variations of solid lithium-ion batteries produced by drop casting and spin coating. From FIG. 4, it can be seen that the voltage variation of solid lithium-ion batteries produced by drop casting and spin coating have the ranges R1 and R2 within ±20 m V. The range R2 of the spin coating method is less than the range R1 of the drop casting method.

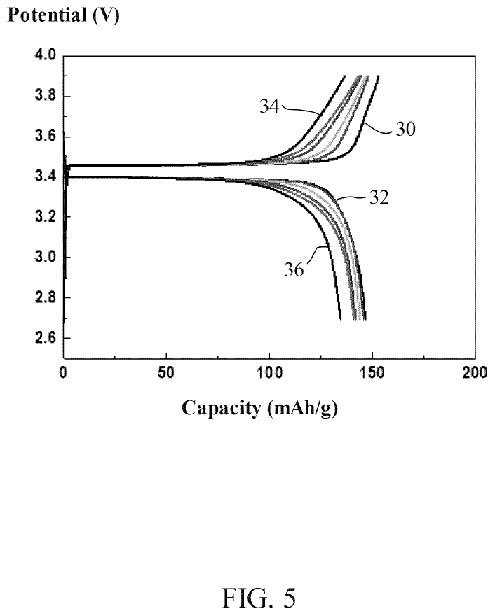

FIG. 5 shows the capacity to potential curves of the solid lithium-ion battery of the present invention after charging and discharging. In FIG. 5, the rightmost curves 30 and 32 are the capacity to potential curves of the first charging and discharging activity, and the leftmost curves 34 and 36 are the capacity to potential curves of the 100th charging and discharging activity.

From FIG. 5, it can be seen that the solid lithium-ion battery of the present invention is better than the conventional solid lithium-ion battery.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A solid lithium-ion battery comprising:
a solid electrolyte; and
a cathode formed on a surface of the solid electrolyte, the cathode comprising lithium metal chloride.

2. The solid lithium-ion battery according to claim 1, wherein the cathode comprises lithium metal and an interface layer, and the interface layer has alloy and an artificial solid electrolyte interphase layer.

3. The solid lithium-ion battery according to claim 2, wherein the alloy comprises lithium calcium alloy, lithium indium alloy, lithium tin alloy, or lithium silicon alloy.

4. The solid lithium-ion battery according to claim 2, wherein the artificial solid electrolyte interphase layer comprises lithium chloride.

5. The solid lithium-ion battery according to claim 1, wherein the solid electrolyte comprises lithium lanthanum zirconium tantalum oxide (LLZTO).

6. A method for manufacturing a cathode of a solid lithium-ion battery comprising:
Step A: coating a metal-ion chloride solvent on a surface of a solid electrolyte;
Step B: drying the metal-ion chloride solvent coated on the solid electrolyte to obtain metal-ion chloride;
Step C: forming lithium metal on the metal-ion chloride; and
Step D: performing an alloying process on the metal-ion chloride and the lithium metal to form an interface layer having alloy and an artificial solid electrolyte interphase layer between the solid electrolyte and the lithium metal, wherein the lithium metal and the interface layer forms the cathode of the solid lithium-ion battery.

7. The method for manufacturing the cathode according to claim 6, wherein in Step A, the metal-ion chloride solvent is coated on the surface of the solid electrolyte by spin coating or drop-casting.

8. The method for manufacturing the cathode according to claim 6, wherein the metal-ion chloride comprises conductor, semiconductor, and nonconductor.

9. The method for manufacturing the cathode, according to claim 6, wherein the metal-ion chloride is lithiophilic.

10. The method for manufacturing the cathode, according to claim 6, wherein the metal ion chloride comprises calcium chloride, silicon chloride, indium chloride, or tin chloride.

11. The method for manufacturing the cathode according to claim 6, wherein the alloy comprises lithium calcium alloy, lithium indium alloy, lithium tin alloy, or lithium silicon alloy.

12. The method for manufacturing the cathode according to claim 6, wherein the artificial solid electrolyte interphase layer comprises lithium chloride.
